(19) United States
(12) Patent Application Publication
(10) Pub. No.: US 2003/0195854 A1
(43) Pub. Date: Oct. 16, 2003

(54) Device and method for the copy-protected distribution of electronic documents

(76) Inventor: Erland Wittkotter, Buende (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/123,266

(22) Filed: Apr. 16, 2002

Related U.S. Application Data
(63) Continuation of application No. PCT/EP00/10256, filed on Oct. 18, 2000.

(51) Int. Cl. G06F 17/60

(52) U.S. Cl. 705/51

(57) ABSTRACT

the invention relates to a device for the copy-protected distribution of electronic documents in an electronic data network which is publicly accessible, in particular on the internet, comprising a document-server unit (20), which is designed to permit download access to a document that may be selected from a large number of documents offered by the document- server unit (20) and an access unit (18) allocated to a user which is designed to implement the download access and to open the downloaded electronic document by means of a playback unit (22), with the electronic document having a document data structure containing document data, preferably in compressed form.

The invention relates to a device for the copy-protected distribution of electronic documents in a publicly accessible electronic data network, in particular the internet, in accordance with the preamble to claim 1. In addition, the invention relates to a method for the copy-protected distribution of electronic documents, in particular to the operation of such a device.

Due to the rapidly expanding use of the internet as a distribution medium, to exchange and sell electronic documents—in this case, as well as text files, this includes in particular audio, video, animation, simulation and program files and mixtures of these—, effective access control, particularly for valuable, copyright-protected files and the prevention of unauthorized further distribution of copies produced without authorization is an increasing problem.

Existing, common methods for improving the copyright protection of (user) files distributed electronically via public data networks concern on the one hand conventional methods for encoding user files of this kind and on the other it is now also common to incorporate so-called electronic water marks in (lawfully distributed) copies of an electronic document, namely individualized electronic markings, which—invisible to the users of the documents in normal use—nevertheless enable a document to be precisely identified (with the possible objective of enabling the identification of the origin of copies distributed without authorization).

However, both methods have the disadvantage that once put into circulation, in particular to private end users, a copy of document (non-encoded or decoded) will be archived and used by the end user for private purposes, with the result that the originator of the work reflected in an electronic file will suffer significant damage from users of this type in possession of a document obtained in an unauthorized (and usually also remuneration-free) manner and an economic advantage (reward) is accrued over those who had otherwise acquired the document in the proper manner.

One particular problem is presented by the distribution of music filed via public data networks, in particular the internet, and it may be assumed that not only will the internet become an important (if not dominating) medium for electronic sales of works of music, the attractiveness of this sales method will also be accompanied by an increase in the potential risk and loss as a result of pirates, who themselves use the internet to make pirated copies available to the public for no cost. For example, the business model of several commercial companies active in this field is explicitly focused on using the internet as a medium for the exchange of electronic (music files), cf the examples of the companies Napster, Freenet and Gnutella.

In practice, in the case of audio files for electronic distribution via the internet, the file format MP3 has become established as the standard, with both legally acquired and also pirated copies from so-called pirate sites (ie servers in the internet offering unauthorized pirate copies) of downloaded MP3 files being available for use by an observer by means of internet service programs commonly found in add-on programs, known as viewers (ie playback devices for electronic files of this type).

The explosive expansion in the number of pirate sites, which are often operated from geographical server sites where a procedure using copyright means is impracticable, intensifies the requirement for effective possibilities for the controlled distribution of electronic documents, in particular works covered by copyrights, such as pieces of music, video clips, films, etc, in order to ensure that uncontrolled electronic distribution of documents of this type renders the underlying artistic and creative activities unattractive and brings them to a halt.

The problem of copy-protected distribution of electronic documents in the internet is intensified by the fact that effective control of the playback units at the user end is virtually impossible. Once again, the example of music files (MP3 format) demonstrates that the creation of electronic files (documents) in MP3 format from sound carriers (CDs) is virtually unavoidable, the same is true of the opposite procedure: the creation of music CDs from MP3 files. The effective restriction of the functions of a MP3 player is also impossible if only because once an electronic document has been opened (played), there is direct access to the digital data flow and then a copy may be made (digitally and with no loss of quality); this is known as the local loopback problem.

Therefore, it is the object of the invention to create a device to the copy-protected distribution of electronic documents, in particular in an electronic data network, such as the internet, in accordance with the preamble to claim 1, in which for the benefit of the document provider it may be achieved, on the one hand, that a document user can only use authorized electronic documents (generally after the completion of a financial transaction to reimburse the document provider) and which also creates possibilities to make the further distribution of electronic documents already present at pirate sites unattractive and hence to stem it.

This object is achieved by the device with the features in patent claim 1 and the method with the features in patent claim 20; advantageous further embodiments are described in the subclaims.

In the method according to the invention, the distribution of electronic documents, ie for example MP3 audio files or JPEG image files, is preferably performed through the agency of internet document servers in encoded form, with, in accordance with the invention, the appearance of the encoded form of the relevant electronic documents being such that the fact that they have been encoded by the computers involved cannot be identified without examining the content of the documents in question. In other words, as far as its data format or file structure is concerned, an encoded MP3 audio file looks exactly like an non-encoded MP3 audio file and it is only when the file is played (opened) on a suitable player (viewer) that it is evident that the encoded file produces an unusable, usually completely chaotic result with no sense as far as its content is concerned. Within the scope of the invention, the term “fully playable” should be understood as follows: an encoded form of an audio, text or video file remains a file with the same format and the same structure, only produces a different result (sometimes drastically) as far as the content is concerned leading to unusability when it is played on the associated playback function. The same applies to fully playable encoded program documents according to the invention; these may be executed and possess all the functions, but the results or output of these functions are meaningless or unusable.

In addition to the security achieved by the encoding (an unauthorized user of the encoded file will be unable to use it and only able to forward it in encoded form), the procedure according to the invention offers the possibility of bombarding existing server units, in particular pirate sites with a large number of documents encoded in the way according to the invention—preferably individually, avoiding the same encoding results—and hence, depending upon the volume and number of encoded documents played, to ensure that, after repeatedly finding that an MP3 audio file which is time-consuming and laborious to download (a short, approximately 3-minute piece of music, may reach sizes of several Mbytes) is unusable, users accessing the server unit in question will lose interest and possibly be inclined to acquire the electronic document legally and unproblematically and hence not simply delete the encoded, and hence rendered unusable, file but make active use of it.

The invention also covers the following possibility: the electronic marking (signature) applied by the signature unit within the scope of the invention or naturally present clearly identifies the electronic document with regard to the reconstruction file needed for the document for decoding, so the electronic data-type marking (signature) adhering to the encoded document may be used by means of the allocation unit (for example, a type of relational database system), either directly to access the necessary reconstruction file or instructions from the database or to obtain an (internet) address (for example, as a hyperlink), via which a suitable reconstruction server may then be addressed as a reconstruction data storage unit with the required file. (Within the scope of the invention, the term “data-type marking” or “signature” should be understood as an identifying feature of an electronic document, which is generated, for example, by calculation (by means of an algorithm or another function), by extraction, comparison, requesting external services, etc and permits a clearly reproducible identification).

This link may then be made, in the way desired for the originator of the electronic document, into the basis of a transaction and accounting process, namely in that an accessing user searching for the reconstruction file matching the electronic signature of the encoded document downloaded by him is provided with this in return for a suitable remuneration and/or registration, with this reconstruction file in particular being able to perform further control functions, for example only a time-limited right of the user to access the decoded document, the right to access only parts of the document (for example, to play the title of a piece of music), etc.

The invention offers a large number of possibilities for realization and in the following description of an example of an embodiment the reference to audio file formats, such as MP3, is for purposes of example only. Within the scope of the invention, therefore, the term “document data structure” covers all inherent structural or format-related limited information components (also known as a “data packet”) occurring in an electronic file; other examples include so-called frames in video or audio files or individual words or sentences in text documents that facilitate content-wise or content-related manipulation for purposes of encoding, without changing the data format (data structure) character of the basic file form.

A particularly favorable possibility of effecting this encoding within the scope of the invention is so-called semantic encoding, such as that disclosed in German patent application 199 32 703.3, and the full scope of which with regard to the modalities of context- and context-dependent encoding should be deemed to be incorporated in this application.

Specifically, therefore, the transposition, removal, addition and/or exchange of the individual effective components relating to content envisaged in accordance with a further development permits the attainment of an encoded document, whose structure, in the way desired according to the invention, is indistinguishable from a non-encoded document, although an appraisal of the content—for example as a video sequence with completely unrelated (sometimes missing) individual images or transposed intermediate images (so-called intra-frames)—is no longer of any use to unauthorized users.

In accordance with a further development, this is achieved by the functions of the encoding unit, which is able to generate the semantically encoded volume data and key data from an original electronic document to be protected (namely the original data volume or useful file) as a reconstruction file. For example, in particular the analyzer unit according to the invention is envisaged in order, within the scope of the specified format structure and/or grammar, to establish the condition for subsequent content- or meaning-related encoding and the manipulation unit connected downstream from the analyzer unit then performs the core operations of semantic encoding, namely the transposition, removal, addition and exchange, on the information components of the original data volume, taking into account the analyzed format structure and grammar.

Here, it is particularly suitable to perform the transposition or exchange operations so that the information component in question is replaced by information components with an equivalent content, structure or grammar, insofar as the result of the operation remains apparently meaningful. Within the scope of the invention, the equivalence unit envisaged in accordance with a further development permits the identification or selection of suitable equivalent information components for this or other operations.

In accordance with another, preferred further development of the invention, another operation is performed by the encoding unit taking into account the grammar, format or syntax of the original document: by the action of the preferably envisaged semantic control unit, the manipulation unit envisaged in accordance with the invention is again able to create an encoding result, which has a grammatical, format and/or syntactic structure corresponding to that of the original file, so that not only is equivalence ensured with regard to the relevant individual information components (eg words in text or frames in a MP3 file), but there is also conformity with the rules relating to structure and/or format arrangements (ie, for example, the arrangement of terms in a sentence in accordance with the rules of grammar) and that insofar, without checking the content, it is impossible to identify that an operation achieving the encoding effect has been performed on the information components.

In accordance with another preferred further development, the manipulation unit is assigned a control unit which randomizes the encoding operation (ie the application and effect of the individual encoding operations): by generating and taking into account a random component, eg a random number generated in an otherwise known way and its consideration during the performance of a number of encoding operations dependent thereon, it is ensured that the encoding of the same original document always produces a different result, ie even under otherwise identical conditions, encoding never produces the same encoding result. This measure again increases the security of the invention.

In addition, it has generally been found to be particularly preferable to give a user applying encoding the option of pre-selecting a predetermined encoding depth (and hence the encoding security): with the described aspect of the invention of semantic encoding, the question of encoding depth correlates with the number of basic operations of transposition, addition or exchange effecting the encoding performed and insofar also determines the volume of the key file generated. Hence, by setting a suitable parameter, the user is able in effect to determine the security level of the encoding operations to be performed, with however, unlike in known, conventional, encoding procedures, in each case the result of semantic encoding producing an apparently correct (ie formally apparently non-encoded) result and the question of whether any encoding has taken place is impossible without examining the content. Insofar, the initial effect of insecurity obtained with semantic encoding actually achieves a certain protective action, without a single encoding operation in the above-described sense being performed.

It has been found that another particularly preferred realization of the invention is to use the conversion unit envisaged in accordance with a further development to output the volume data as a document, while the key file may be created and output as an playable script file in a suitable script language, eg Visual Basic (Script), Javascript, etc, with the advantage that, in particular in connection with network or internet-based applications, the original data may be restored in a particularly simple way, in the simplest way by running the script directly responsible for the restoration (which is introduced via a suitable connection allowing for the interests of the person seeking protection).

Realizing the reconstruction of the reconstruction file as a script file particularly conveniently opens up an alternative or additional possibility for protecting the electronic document against copying: in accordance with one embodiment of the invention, the reconstruction file does not (solely) influence the electronic document (and hence renders it usable or unusable), it also has a direct impact on the mode of operation of the playback unit and/or the reconstruction unit: a case of this type occurs, for example, if the playback (itself) is script-controlled in a viewer and hence dependent upon parameters or commands and here the invention facilitates the manipulation of the playback functions (corresponding to the reconstruction functions in the reconstruction unit). Another example would describe a situation in which a program class or method required for playback or reconstruction for the reconstruction or playback object is introduced individually for security purposes or selected (from a large number of possible existing options) in accordance with the reconstruction data (preferably in the form of a script file). In an extreme case, the security effect achieved by the invention consists entirely in the prevention of normal playback or its realization by the reconstruction file with an otherwise unaltered document.

Within the scope of the invention, either the signature checking and administration and the allocation of the reconstruction files may be left to one party (ie, the document provider, for example), alternatively it is in particular also envisaged, in the style of an internet-wide association of different document providers, that a large number of reconstruction data storage units will be provided to which the, preferably central, common allocation units refer via suitable hyperlinks or other linking methods.

Here, it is also within the scope of the invention to realize the reconstruction data storage unit both by means of one or more server units via the internet (in this case, within the scope of the invention, the term “reconstruction server unit” would also be used) and by providing a local data storage unit, in particular in the style of local server functions at the user's end, for example on a PC or LAN configured for access purposes. The result is that the although the invention is particularly suitable for operation in conjunction with an electronic data network accessible to the public, in particular the internet, certain embodiments of the invention are feasible in which the download access to the document server unit is also performed locally, as is access to the reconstruction data storage unit (reconstruction server unit) and access to the access unit. It is also within the scope of the invention to provide the reconstruction unit locally or alternatively (or simultaneously) to provide this at the server end.

Even if it is not necessary for there automatically to be a direct financial interest on the part of the document provider behind every instance of copy-protected distribution (it may often rather involve an interest in keeping control and merely in diluting unauthorized distribution), with the increasing commercialization of the internet and the establishment of the internet as an effective sales route for audio files, particular significance will be attached to suitable accounting methods.

In accordance with a further development, it is therefore envisaged that a user who has already obtained a (encoded) document from a document server unit, establishes the circumstance of the encoding on attempting to play it back and is then offered by means of suitable functions in his access software (a suitable way to achieve this would be plug-ins in conventional internet browser programs) the opportunity to first establish—for no cost—by on-line interrogation of the allocation unit whether and where there is a suitable reconstruction file and then the server offering the allocation unit (as a database system) either makes the reconstruction unit directly available to him for downloading or offers a hyperlink to a suitable, separate reconstruction server. By means of usual identification and accounting processes, for example by entering credit card information, the transmission of the reconstruction file to the user (and hence his opportunity to access the non-encoded document) may be linked to the desired financial transaction, with to this end, suitable function modules being provided in particular in the reconstruction server.

In order to realize the data-type marking (also known as a signature) within the scope of the invention, it is only necessary for an encoded electronic document file ready for downloading to be given a clear enough electronic identification to enable an associated reconstruction file to be found through the agency of this signature. Nevertheless, it is preferable to perform the calculation of a signature of this type on the basis of otherwise generally known algorithms and with regard to the overall file so that any change to the sequence of the file's data content or the deletion, alteration or addition of data may be determined from corresponding impacts on the signature.

To be more precise, a preferred way to generate the signature consists in using an algorithm (known and executed at the provider and the user ends) from the data in the file to calculate a value which clearly identifies this file and its structure and in particular also the sequence of the data content. Manipulation in the file, in particular in the sequence of the data content, would then have the result that on the (repeated) calculation of the signature, this would be different from the original signature, therefore enabling not only the clear identification of specific (encoded) document files, but also in particular the identification of any alterations. (In this context, it should also be explained that the calculation or determination of a signature at the client's end may also take place passively, in particular by control or interrogation at the server end).

It is important for the invention that, through the agency of an on-line contact, which makes the allocation unit signature left when downloading an encoded file accessible to a user, by means of which the user is then assigned a path in the described manner showing how he may obtain the reconstruction file specifically required. In accordance with a further development, it is therefore preferred that in particular these processes, namely primarily the notification of the signature or the interrogation of a path allocated for the reconstruction file, be performed automatically, for example by means of suitable plug-in functions in the user's internet access and playback software.

It is also advantageous in accordance with a further development, in an otherwise known manner, to provide a properly produced file, namely after obtaining a reconstruction file and its merger with the encoded electronic document, with an individualized electronic water mark so that it is possible to trace unauthorized transmissions of the recombined document. It is also preferable to realize this water mark formation by means of reconstruction instructions contained in the reconstruction file, so that in this case a reconstruction file has two purposes: restoration and clear identification of the restored document.

The water mark generated may also be provided with a time stamp. The characteristic fact about a water mark is that it can only be recognized by the issuer and that even with minimum changes to the data does not lose its characteristic of identifying its user.

As a result, the invention offers the possibility of developing a comprehensive system to protect the copyrights of electronic documents in an electronic data network, in particular in the internet, which reconciles the justified interest of the document (content) provider in preventing the abuse and possible compensation with the interest of (honorable) users of using the advantages of the internet for example, in order to be able to use the full range of electronic media at short notice, quickly and comfortably (and as a result also cost-effectively). On the other hand, the invention may also be used to ensure that the only websites or servers to offer usable electronic documents are those which (without further transaction), before playing on a server, have fully checked the document in question, eg. an MP3 piece of music, by listening (so-called quality sites). If, however, server-end providers of this type proceed improperly, due to the operations performed, they would inevitably attract attention and hence make the protection of copyright easier.

While up to now, in particular from the point of view of providers or issuers, effective control was quite impossible, this is achieved by the invention by shifting competence and responsibility for legal reproduction to the internet units “electronic allocation unit” or “reconstruction server unit” in conjunction with the user-end local units.

In accordance with the currently valid agreements between issuers and the collecting societies, an issuer's responsibility for further distribution ends after transmission and the appropriately agreed commercial accounting for the data between the publication server and the customer.

The main obligation of the collecting societies is then to prove the number of direct downloads. A fee to be paid to the collecting societies is estimated from the number of possible further transmissions, generated from statistical data. Therefore, a current distribution concept may be described using the metaphor of a tollgate at the issuer's end.

If, as achieved by the invention, client software has to be installed by or for the distributed document, which then compels server contact for the reconstruction of the non-encoded content, this will create a tollgate at the user's or client's end, which has further advantages over one at the server's end. For example, even if no material (financial) compensation is demanded, the transmission of information on the signature or release server realizes very precise marketing, application and usage statistics. If, in accordance with the invention, use by a user may be registered more precisely, a provider of digital documents in the internet is only obliged to pay the licenses or fees linked to a specific use to a collecting society. This provides in particular an opportunity to organize and allocate remuneration of the copyright holders more fairly, as due to the determination and registration of use, the invention in accordance with a further development also makes possible the basis for statistical findings on the usage pattern and usage of specific electronic documents.

In addition, it is possible to develop new marketing models in which the use of digital document files (as they may now be recorded better) are paid for by a server or transmitter for advertising or for image reasons.

Other advantages, features and details may be derived from the following description of preferred examples of embodiments and using the diagrams—these are

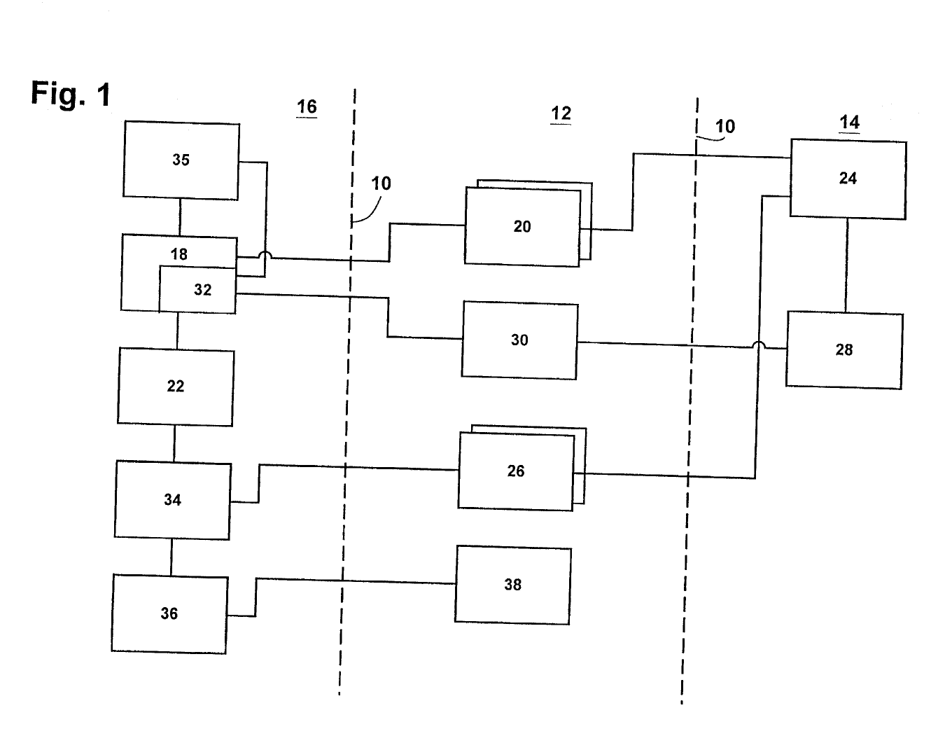

FIG. 1: a schematic block diagram of the device for the copy-protected distribution of electronic documents in accordance with a first, preferred embodiment

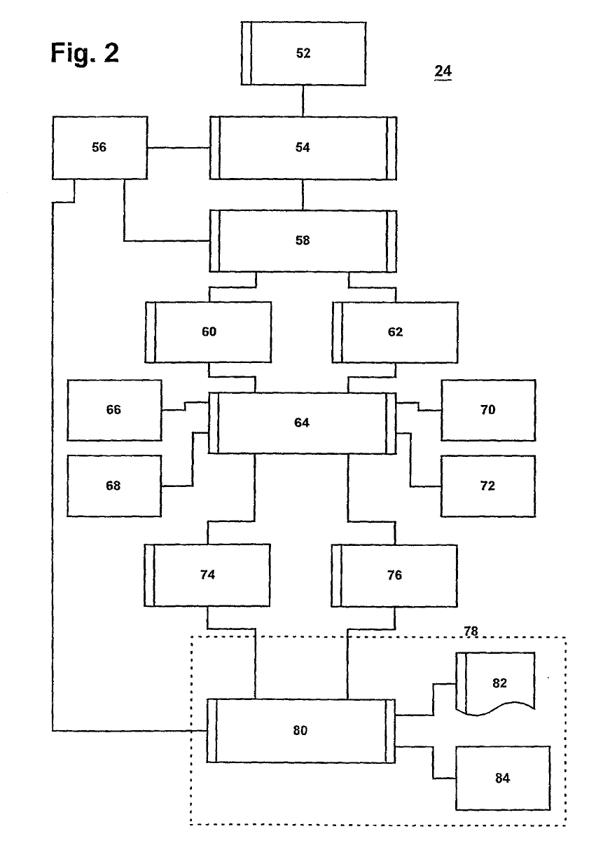

FIG. 2: a schematic block diagram with an example of the realization of the encoding unit 24 from FIG. 1.

The system graphically represented in FIG. 1 separates by means of symbolic limits 10 a publicly accessible data network, in this case the world wide web (www) as an internet system 12, from a provider 14, in this case a provider of digital audio documents to be sold via the network 12 and from a user 16, who, by means of a symbolically shown access unit 18 (usually a computer unit fitted with common internet access software) is able to access in an otherwise known manner an accessible document server unit 20 via the electronic data network 12. This takes place by means of generally accessible, common internet protocols, for example TCP-IP, HTTP or FTP, with the document server unit 20 being designed to display a selection of different electronic documents for a (word missing) accessible by means of the station 18 and to subsequently facilitate the downloading of a selected electronic file.

Insofar, this is standard technology according to prior art which requires no further explanation.

The documents offered in accordance with this example of an embodiment are so-called sound or music files compiled using the MP3 file format and which may be played on a suitable playback device 22, which particularly preferably is part of the user-end access unit 18 or allocated to this (player or viewer as playback unit; these are suitable for reading the MP3 file format and converting it back into audio signals or music; once again, this has been long known from prior art).

Structurally, the MP3 file format comprises a header and a quantity of data unit (data packets, also known as frames) each containing the music data in compressed form. The size and structure of the frames are described in more detail by the header data and hence exactly defined. Specifically, every frame compresses a large number of audio access units (AAU), which each of these AAUs standing for a predetermined time slot of the audio signal (for example, 8 or 12 msecs). According to the MP3 standard, the temporal audio signal is discretely FFT transformed, with the transformation being performed on the basis of 32 pre-specified frequencies and the data from an FFT transformation being stored in an AAU, corresponding to the usual procedure when generating an MP3 sound file.

According to the invention, however, a MP3 sound file stored in the document server unit 20, held ready for access by the user 16 and uploaded by the provider 14 into the document server unit 20 is encoded—namely by means of an encoding unit 24.

To be more precise, the encoding consists in the fact that the individual frames of the MP3 file structure were transposed in a sequence which does not correspond to the original music signal, frames were removed, additional, meaningless frames were added and/or frames from two or more independent audio files were transposed, with an encoding manipulation of this type—hereinafter also referred to a semantic encoding—producing the actual structure of the MP3 format, namely the header and the frames allocated to this. In other words, the playback unit 22 (and all other player or viewer units suitable for MP3) will be able to open and play the MP3 file encoded in this manner. However, the manipulations performed mean that the received signal, which has been converted back into an audio signal by MP3, makes no sense to the user as due to the transpositions, replacements, removals and additions of frames, the original sound signal has been so alienated that the original piece of music or similar content of the MP3 file is no longer usable for a user.

In an advantageous way according to the invention, the provider 14 performs the uploading of a file encoded in the way described into the document server unit 20 so that not only is there an encoded version of the MP3 file here, but also a large number, for example 1000 or 2000, of identical or different encoded versions of the same piece of music (with, as explained, for a user 16, interrogating the document server unit 20 with its list of contents or one of the search engines allocated to the files offered and not described in any more detail, the circumstance of encoding being unidentifiable, as the MP3 format is also retained for the encoded files).

This measure is based on the fact that a large number of the document server units in the internet, for example offering MP3 music files, are so-called pirate sites, namely internet stations which offer pieces of music for arbitrary, general cost-free, downloading to any user in a manner not authorized by a provider with rights under copyright law or similar laws, with usually the distribution of the pieces of music created or sold by the provider being now out of his control and insofar extensive damage occurs.

The invention described in the context of the invention, however, causes a document server unit as a pirate site to be bombarded with a large number of MP3 files—which are not readily usable from the user's point of view, so that the probability of a user downloading a non-encoded (and hence usable without difficulty) is rather low. Merely the fact that the user, frustrated by the negative result when opening the downloaded, encoded music file (with current data volumes, involving downloading 2 and 4 MB with typical pieces of popular music) becomes demotivated and refrains from the future use of this document server unit 20 or is prepared to download and install the software component offered to him which will then notify the signature server unit.

However, by means of another measure in the context of the invention, it is achieved that not only the described effect prevents the further distribution of unauthorized music files (and obviously other electronic data files as well) or at least dilutes it, in addition the user 16 is offered the opportunity of converting the encoded MP3 document downloaded by him from the document server unit 20 into an non-encoded version, so that after the stages to be described in the following he becomes a legal user (and from the point of view of the provider 14 a potential source of turnover).

The provider 14, who has encoded his MP3 file in the way described by means of the encoding unit 24 and loaded onto the document server unit 20 in the internet 12, creates with the encoded form of the file an associated reconstruction file, ie a file containing the necessary instructions to return the transposed, exchanged or replaced frames in the MP3 file back to their original form. A reconstruction file of this type individually allocated to an encoded MP3 file will be played back on an reconstruction server unit 26 also on the internet. A possible further development of this realization of the invention consists in that instead of one reconstruction file, a large number of reconstruction files for the reconstruction of an electronic document are generated and made available, with, however, this large number of reconstruction files differing from each other and being realized so that only one of this large number of files facilitates the restoration of the original (complete) correct content, while the other reconstruction files generated in parallel when used together with the reconstruction unit produce a result which although it apparently corresponds to the original non-encoded electronic document file, has a different content and hence again achieves a certain encoding effect (by, for example, unusable passages being formed at certain points in certain areas of an MP3 music file, while otherwise the file is in the original, non-encoded version). A large number of possible reconstruction files of this type provided in accordance with a further development will supplement the security effect of the invention by the dimension of the insecurity represented by an unauthorized access, namely with regard to the question which of the large number of theoretically possible reconstruction files, is actually the correct one. (The correct selection is preferably the result of a properly performed identification and/or authentication process, which again preferably is implemented by means of a basic operating system environment).

A logical link (and hence the identifiability and accessibility of the reconstruction file for an MP3 sound file) is achieved by a so-called signature being calculated for an MP3 sound file, ie a mathematical algorithm is applied to the encoded file and as a result a signature is formed in the form of a string of characteristics or a file which is characteristic for the content and sequence of the components contained in the encoded MP3 file. This signature calculated by means of a signature unit 28 at the provider-side 14 will be played to a signature also on the internet so that a user-end database unit for interrogation provided therein in the form of a concordance table may usually contain and create a (usually clear) link and relationship between the signature of an encoded MP3 document and the name and location (eg link) to an associated reconstruction file.

At the user end, the local access unit 18 may, by means of a embedded functional unit 32 in this, preferably in the form of a plug-in, make contact with the signature server unit 30 in the electronic data network, after a local signature unit 35, which is also allocated to the access unit 18 (or embedded in this) has used the locally known (general) algorithm to calculate the valid signal for a special (encoded) and downloaded MP3 file.

In the described embodiment, the network access by means of the functional unit 32 then makes available the locally calculated signature (by means of unit 35) to the signature server unit 30 and by means of the concordance table stored there, the user 16 receives from the signature server unit 30 a file name and an address (link) for the reconstruction file associated with the transmitted signature.

This then enables the user 16, to generate the non-encoded, ie the, from the user's point of view, usable, version of the piece of music from the encoded MP3 file available to him with the playback unit 22, with, for the purposes of decoding, a reconstruction unit 34 being provided locally, which may also be realized as a plug-in and which—by means of a reversal of the function of the provider-end encoding unit 24—cancels the encoding by performing the reconstruction instructions in accordance with reconstruction data obtained from the reconstruction server unit.

However, usually the downloading of the reconstruction file from the reconstruction server unit 26 for the purpose of generating a non-encoded local MP3 sound file is linked to the performance of a payment or accounting procedure, ie the user usually pays a predetermined sum of money or a similar quid pro quo in return for the reconstruction server unit enabling him to obtain a decoding or reconstruction possibility matching the MP3 file available to him in the way specified by the signature server unit. To this end—in an otherwise known way—there is an identification and accounting unit 36 at the user end, which, in particular also as a function of the access unit 18, also makes user data available to an accounting-identification unit 38 allocated to the reconstruction server unit 26 in such a way that by means of the reconstruction server unit 26 and the associated accounting/identification unit 38, the user may be identified, possibly his credit card number or a similar payment method recorded and a corresponding payment entered or entered or offset against an existing balance.

In the way described, therefore, the object on which the invention is based, of curtailing the unauthorized distribution of electronic files may be effectively attained: not only will the (massive) uploading of encoded, and hence as such unusable to the user, MP3 files (without, however, this being identifiable without actually downloading and playing back) cause a significant amount of uncertainty and frustration, which after repeated failures should definitely deter users from accessing a particular document server unit (pirate site) again, in addition the user will be given the opportunity, preferably by means of an accounting procedure, of encoding the file loaded and make it usable once more.

Although this example of an embodiment referred to MP3 music files, the invention is not restricted to this data format—in principle every electronic file format of an electronic document requiring protection and offering the possibility of semantic encoding in the way described above is suitable for the application of the invention.

However, due to the commercial potential, MP3 evidently faces a particular problem of expected, massive damage from illegal distribution, which is why this example of an embodiment was selected.

In addition, for the semantic encoding of in particular the MP3 format, it should also be explained that due to the fact that the frames are independent of each other, they be readily transposed with each other. Advantageously, a change of this kind may not be determined by machines or algorithms. Alternatively, a change to the header would render the MP3 document completely illegible, but due to a large number of header entries, in some circumstances, it is possible to identify and correct a changed header.

In addition, MP3 also offers the opportunity of transposing the AAU within them or FFT factors may be changed, so that a played back audio frequency changes drastically. MP3 could also offer the opportunity of exchanging or audio files or running them in parallel in the time specified by the AAU, so that two or more audio signals may be integrated in parallel, possibly in the same file. A relevant reconstruction instruction (an associated reconstruction file) could then have the appearance that according to the instructions, the only data to be filtered out of such a file are those to be identified with a specific audio signal.

Generally, however, as explained, the principle of semantic encoding extends beyond the MP3 format and applies to other document structures, with it being particularly suitable to perform the semantic encoding operations of the object level of the file structure format in question.

The invention also offers the opportunity, by means of a suitable design of the user- or access-end functional components, to further increase control over any illegal document files or to procure the origins of illegally procured documents: for example, it is particularly preferable for the functional unit 32 to be designed so that after the downloading of (an arbitrary) MP3 file, it automatically performs a selection or access procedure on the internet signature server unit 30 and transmits to this the locally calculated (unit 35) signature of the MP3 file in question; if the MP3 file was the subject of a previously performed on-line contact with a document server unit 20, in parallel with the transmission of the signature to the signature server unit, a path (link details) may be transmitted indicating the address from which the associated MP3 file originates.

In particular, the detection means for the signature server unit 30, that this involves an unknown signature, could then trigger further processing stages, for example the further pursuance of a potentially, illegally obtained (or possibly not encoded at all) file.

In addition, the unit 32 may be designed so that, during the determination of the source of the data, it also determines the names and addresses of the servers (by means of common internet trace technologies) used for the transmission of the data. In this way, it is possible to generate a profile which may be used to investigate more precisely the document servers, which cannot be penetrated by the encoded documents, but which have been identified by the statistics at the signature server as particularly dangerous and comprehensive pirate sites. The information found in this way could then be used to provide evidence and used for the disconnection of the service by the content providers or for the selective filtering out of the inquiries directed at this site by the network providers.

Although as shown in FIG. 1, signature server unit 30 and reconstruction server unit 26 are in principle (spatially) separated units in the internet, with it in particular also being envisaged that a (central) signature server unit will be able to issue references to a large number of different reconstruction server units, it is in particular also possible that a provider integrates a signature server unit and a reconstruction server unit, insofar, therefore, on receipt of a relevant user inquiry, the signature server unit is able immediately to send a suitable, associated construction file (if applicable, after a financial transaction) to the user.

With reference to FIG. 2, the following describes a practical realization of the aspects of the invention concerning the infrastructure for the semantic encoding.

FIG. 2 shows in a schematic block diagram a representation of the structure of a key generating and administration unit with the associated functional components within the scope of the invention which may be used, by means of the technology for semantic encoding according to the invention, to convert documents to be protected into protected volume files and the associated key files. Here it is possible in connection with the embodiment shown in FIG. 2 in particular, to generate not only one (on restoration leading to the original, correct dataset) key dataset, but a large number of key datasets, so that also by means of this aspect of the existence of a large number of possible keys (of which again one leads to a correct result in terms of content and not merely an apparently correct result), the security of the invention may be further increased.

FIG. 2 will be described using the example of an electronic text document in a common format (eg Microsoft WORD) and compiled by suitable text editors. The text document comprises the sentence

Peter goes at 20.00 hours to the station. The train is punctual.

is stored in storage unit 52 in accordance with FIG. 2 and is to be semantically encoded in the way described in the following by the action of the other functional components shown in FIG. 2.

A read/access unit 54, which works together with a format data unit 56, connected downstream to the document storage unit 52 determines that the above document stored in the storage unit with MS-WORD format structure (ideally the format data unit 56 contains all common format or structural information data formats) and accesses the text document in the document storage unit with these (file-related) format information. The analyzer unit connected downstream from the read/access unit 54 is now able, on the basis of the document information read by the read unit 54, to analyze and evaluate it, with the analyzer unit 58 both dismantling the electronic document into its individual information components and storing these in an information component storage unit 60 (in this case, this would be the individual words) and also identifies the document structure as a structure of two sentences limited by full stops and stores this document structure in the document structure storage unit 62 in dismantled form. Insofar, the content of the unit 62 takes on the character of a document specific metafile which even later encoding processes will be able to access (if applicable, selectively only).

Specifically, the content of the document structure storage unit, could look as follows after the analysis of the original document by the analyzer unit:

Sentence 1 (1, 2, 3, 4) Sentence 2 (1, 2, 3)

while the information component storage unit 60 contains information components corresponding to this structural analysis, ie words:

| | |
|---|---|
| (1.1) | Peter |
| (1.2) | goes |
| (1.3) | at 20.00 hrs |
| (1.4) | to the station |
| (2.1) | The train |
| (2.2) | is |
| (2.3) | punctual |

With this important preparation for the subsequent performance of the encoding operations, it is now possible to perform the basic operations of semantic encoding on both the individual information components (in this example, the individual words) and on the sequences of information components or structures, namely transposition, removal, addition, or exchange. Here, an essential protective effect of the semantic encoding in accordance with the invention consists in that these operations cannot be performed arbitrarily, instead they are performed with observance of the rules of grammar, syntax and/or format, so that the result of the encoding appears (ie without an examination of the content) to be correct, in other words, it is not evident that this is in fact an encoded result.

In this example of an embodiment, the encoding unit would produce the following text from the above-cited electronic document:

Thomas comes at 16.00 hrs from the graveyard. The train is punctual.

Without knowledge of the true content, this sentence appears to be an open non-encoded result, so that an essential, protection-justifying effect of the invention consists in the mere fact as a result of this text, a person accessing it would not even gain the impression that it was encoded and hence refrain from accessing the text from the beginning.

Specifically, in this embodiment of an example, by means of the action of an equivalence unit 70 (which in its simplest version could be understood as a table or database of equivalent, ie. corresponding and exchangeable, terms), the following may be performed: the content component “Peter” in the original document has been replaced by the grammatically equivalent content component “Thomas”, with the sentence structure and grammar being retained, but the sense of the original document being destroyed. In a similar way, the content component “goes” in the original document has been changed to the equivalent component “comes”, the content component “at 20.00 hrs” has been replaced by the “at 16.00 hrs” (here, it was determined by means of the action of the equivalence unit that numerical data in the form of a time were involved, so that manipulation within the permissible times was possible) and the content component “to the station” has been replaced by the content component “from the graveyard”. Here, a semantic control unit 72 also connected to the manipulation unit 64, which influences the encoding operation described ensures that the encoding result “ . . . comes . . . from the graveyard” is grammatically and syntactically correct, insofar as it cannot be identified as having been manipulated. (The world “to” would also have been correct here). The manipulation unit 64 and the interacting equivalence unit 70 and/or semantic control unit 72 also determined that the content component “the train” in the following sentence is in a contextual relationship with the newly introduced content component “graveyard” in the preceding sentence, so that even without the encoding of the second sentence, a completely different meaning (and hence an encoding effect) is obtained

As the result of these simple encoding operations described, the result of the encoding

“Thomas comes at 16.00 hrs from the graveyard. The train is punctual.”

is output as volume data and stored in a volume data storage unit, while a key permitting reconstruction (in this example, information on the transposed words with their position in the sentence and in the relevant terms regarding content) is stored in a key data storage unit 74. Correspondingly, the associated key file for the storage unit 74 may look as follows (in the following example, the reconstruction interprets the command EXCHANGE to perform the transposition identified in the argument):

EXCHANGE (1.1: Thomas)

EXCHANGE (1.2: comes)

etc.

In a further development of this embodiment, the vocabulary of the command language is itself dynamic and may be changed by the functions of a scripting language; in this way, the EXCHANGE command could be replaced by another arbitrary expression.

In accordance with another preferred embodiment of the invention, it is envisaged that a large number of key files will be generated of which, however, only one will generate the correct reconstruction result. Correspondingly, key data 2 could start as follows:

EXCHANGE (1.1: Rudiger)

(rest as key file above);

Key file begins with

EXCHANGE (1.1: Claus)

etc.

In the embodiment in FIG. 2, an output unit 78 is also connected downstream to these two storage units, which in a particularly simple way prepares the key data 74 in the form of a script and can output it as an playable script file 84; this is performed by the agency of a conversion unit 80, which, in an otherwise known way, generates a volume document 82 corresponding to the encoded version from the volume data in storage unit 76 and from the index or reconstruction data in the storage unit 74 a structural description, script, eg as JavaScript, XML, VB-Script which may be executed independently with a suitable runtime environment and which may then be independently processed during the execution of the volume document 82 and return to the original, non-encoded form.

Correspondingly, the file 84 may be stored as a reconstruction file in the reconstruction data storage unit 26 (FIG. 1), the file 82 in the document server 20.

In addition, the schematically shown embodiment shown in FIG. 2 is suitable not only to generate one key file for the storage unit 74 (or as an playable script file 84), but also a large number of these, of which ideally once again only one will produce an factually correct result as regard to content, while other key files as scripts trigger an decoding process which, although it produces a meaningful (and hence apparently correct) result, does not have the same content as the original version. Once again, this provides a further increase in the encoding security. Here, it should be immediately evident that even slight deviations in content completely destroy the (forming the actual value for a user) sense of the original document, so that possibly only slight modifications or a low number of encoding operations (followed by a correspondingly small script file as key data) are required to achieve the envisaged protection, right up to the above-mentioned non-encoding of the original file, whose protective function is only derived from the circumstance that person making the unauthorized access is unsure whether he is dealing with open content (ie corresponding to the original) content or with encoded content (ie not corresponding to the original content).

As mentioned, the invention is not restricted to the example of text files described. For example, it is particularly suitable for encoding any other types of electronic documents in the way described in principle, as long as these electronic documents have a suitable structure of content components for the basic operations of transposition, removal, addition or exchange. Typical applications include in particular music files, which are usually in MP3 format, where it is possible within the context of the invention to exchange, remove or transpose the data structures (so-called frames) specified by the MP3 format individually or in blocks (ideally also by time or section, relative to the piece of music in question). The same applies to image and/or video files, because even the usual, known data formats are based on a sequence of frames as content components (in the case of images or electronic videos, these are the individual images in question), which may be manipulated in the manner according to the invention.

Other possible and favorable further developments of the invention envisage that a reconstruction file, in particular in the form of a script or similar, exists in ASCII or HTML format. In particular with regard to a firewall protecting a client and/or server unit, this offers simplified possibilities of penetrating a firewall of this type undisturbed.

Another advantageous further development of the invention envisages embedding a reconstruction file suitably in electronic document data (of the same or another data type) and in such a way that the format and (reproduced) content of a guest file of this type remains unchanged; in a particularly advantageous way, an area of the guest file which does not have a directly effective content, eg commentary or information areas, is suitable for the concealed reproduction of reconstruction files of this type, with the objective of further increasing security.

In particular, the option of realizing the reconstruction files in accordance with the invention as scripts offer a large number of possibilities for further development: for example, script-controlled merging within the context of the invention as a further development improves the flexibility or further increases security due to the fact that not only one script file as a reconstruction file facilitates the restoration of the non-encoded form of the electronic document by merger, but a large number of scripts as reconstruction files is needed, which, for example, cover pre-determined time segments of the electronic document and are then called up in succession. As an example, the invention may be realized so that in each case a script file as a reconstruction file for a time segment of about 30 seconds of an MP3 piece of music permits reconstruction and then a further reconstruction makes the (again script-controlled) call up of a subsequent, further script file necessary. In addition to an increased security effect, this provides possibilities for the context-dependent generation or reconstruction of the original document, including the possibility of restoring different variants of the original document in a context-dependent and selective way.

As a result, the achievement of the invention is that in fact an ordering system is created for electronic documents distributed in an electronic data network which takes into account the interests of the authorized providers of the documents in a much better way than is the case with the conventional, uncontrolled and uncontrolled distribution of files. For example, the invention is in particular suitable for use with usual, otherwise known identification and authorization procedures. The invention is particularly relevant for pieces of music, because the music industry see the free uncontrolled distribution of MP3 files over the internet as existing threat for their commercial survival. However, apart from added security technology and access technology, the new music formats favored by the music industry have no additional advantages for the user. The greatest drawback is that the files protected in this way are easy to identify and in a direct comparison with MP3 files have disadvantages with regard to usability, so that when a user is deciding which file to download, he is able to avoid the protected file data. This decision on the part of the user is assisted by the fact that it is evident to the user before downloading which files are not protected and which are protected.

The object of the invention as described was not the complete suppression of the illegal use of copyright-protected data. Rather, the intention of the invention was to change the attitude of users so that the use of easy-to-download data is scrutinized and the reliable (and not further scrutinized) use of data of unclear origin should always be called into question.

1. A device for the copy-protected distribution of electronic documents, in particular music with
a document server unit (20) which is designed to facilitate download access to a selected document from a large number of documents offered by the document server unit (20),
an access unit (18) allocated to a user which is designed to perform the download access and to open the downloaded electronic document by means of a playback unit (22),
with the electronic document having a document data structure which contains document data preferably in compressed form.
characterized in that
a document provider (14) is allocated an electronic encoding unit (24) to generate an encoded form of an electronic document and to generate an associated reconstruction file, with the encoded document (82) in encoded form being fully playable but not usable by the user (16) in the envisaged way and the existence of the encoding of the electronic document being unidentifiable from the document data structure by a machine without an examination of the content of the document and with the information contained in the reconstruction file (84) being suitable in conjunction with the encoded document to restore the original document from the latter,
the document provider (14) is allocated an electronic signature unit (28) to generate a signature for an encoded document (82), with the objective of facilitating the allocation of a reconstruction file to an associated encoded form of the electronic document,
a reconstruction data storage unit (26) is assigned which is designed to store a large number of reconstruction files and facilitates download access by the user's access unit (18) to a selected reconstruction file (84),
an electronic allocation unit (30) in which information for the establishment of a connection or link to a reconstruction file (84) to be selected is entered and may be interrogated and delivered by the user's access unit (18)
a user-end signature unit (35) which generates a signature allocated to an encoded document and with which the information on the establishment of a connection or link in the electronic allocation unit (30) may be accessed
and the access unit (18) which is designed to work with a reconstruction unit (34) which is designed to merge a downloaded encoded form of an electronic document with an associated reconstruction file downloaded from the reconstruction storage unit (26) so that an electronic document in a non-encoded form usable to the user is generated.

2. A device as claimed in claim 1, characterized in that the electronic encoding unit (24) is designed so that the electronic encoding unit (24) is designed so the operations for encoding an electronic documents may be performed on data packets of the document data structure: transposition, removal of a data packet, addition of a data packet to a pre-determined position in a sequence of data packets or exchange of a data packet for a data packet which is preferably not contained in the original electronic document, in particular by means of computer access to the electronic storage areas of the electronic encoding unit allocated to the document data structure's data packets.

3. A device as claimed in claim 1, characterized in that the electronic encoding unit (24) is designed to generate the reconstruction file with details of the transposed, removed, added or exchanged data packets.

4. A device as claimed in claims 2 or 3, characterized in that the electronic encoding unit (24) comprises
an analyzer unit (54, 56) designed to access an original dataset in the electronic document and for the electronic recording of at least one sequence of information components in the original dataset as a reaction to pre-defined or determined format or structure data in the original dataset,
a manipulation unit (64) connected downstream to the analyzer unit which is designed to
transpose or remove an information component in the original dataset or add an information component to a pre-defined position in the sequence of information components or exchange an information component for an information component preferably not contained in the original dataset, and to
generate a key dataset as a reconstruction file with details of the transposed, removed, added or exchanged information components, which is designed to permit the restoration of the original dataset.

5. A device as claimed in claim 4, characterized in that the manipulation unit (64) is allocated an equivalence unit (70) which keeps ready an electronically stored equivalence information component for at least one information component in the original dataset, with the equivalence information component being designed so that its grammar, format or syntax matches that of the associated information component.

6. A device as claimed in claims 4 or 5, characterized in that the manipulation unit is designed to work with a semantic control unit (72), which is configured so the transposition, removal, addition or exchange takes place within the grammar, format or syntax, determined by the format or structure data.

7. A device as claimed in one of claims 4 to 6, characterized in that the manipulation unit (64) is allocated a random control unit (68) which controls the transposition, removal, addition or exchange by the manipulation unit affecting individual information components or sequence(s) of information components randomly.

8. A device as claimed in one of claims 4 to 7 characterized by a encoding parameter unit (66) allocated to the manipulation unit (64) which is designed to store or set pre-defined parameters for the transposition, removal, addition or exchange by the manipulation unit affecting in particular an encoding depth achieved by the amount of transposition, removal, addition or exchange.

9. A device as claimed in one of claims 4 to 8 characterized by a conversion unit (80) connected downstream to the manipulation unit (64) which is designed to generate an electronically transmissible volume file from the encoded dataset as an encoded form of the electronic document and a playable program or script file from the key dataset as a reconstruction file.

10. A device as claimed in one of claims 2 to 9, characterized in that the manipulation unit is designed to generate a large number of key datasets as reconstruction files, of which at least one does not permit the restoration of the original dataset when merged with the encoded form of the document, but which after the merging leads to a dataset which matches the syntax, format or grammar of the original dataset.

11. A device as claimed in one of claims 1 to 10, characterized in that the reconstruction unit (34) or the playback unit (22) comprising at least one programming functional unit, which in particular may be influenced by elements of a reconstruction file, which, to perform an operation required for the merger of the encoded form of the electronic document with the associated reconstruction file for the generation of the electronic document in the usable form or to open it, may be configured and influenced so that the merger or opening only produces the usable, non-encoded electronic document with a pre-defined configuration of the functional unit, with the functional unit preferably being realized as a program library for the reconstruction or playback unit, or as a file which may be executed on an operating system platform in the access unit, as a command line or as an element of a programming or script language controlling the reconstruction unit or playback unit.

12. A device as claimed in one of claims 1 to 11, characterized in that the electronic allocation unit (30) is a database server connected to an electronic data network, which, together with the reconstruction data storage unit (26) forms a common server unit or which is spatially separated from the reconstruction data storage unit (26) and with information from (30) facilitates the establishment of the connection or link for a large number of different reconstruction server units (26).

13. A device as claimed in one of claims 1 to 12, characterized by a user identification or accounting unit (38) allocated to the reconstruction data storage unit designed to record data individualized by a user, to perform a financial transaction with the user or to allocate or manage user- or user-group-specific access rights.

14. A device as claimed in one of claims 1 to 13, characterized in that the user-end and electronic signature units (35, 28) are designed to perform a reading operation based on an algorithm common to the signature units of algorithmically determined data positions in the encoded document to generate the data-type signal.

15. A device as claimed in one of claims 1 to 14, characterized in that the electronic document is an audio, video, animation, simulation multimedia or program file or that the document data structure is selected from the group comprising the data formats MP3, MPEG, XML.

16. A device as claimed in one of claims 1 to 15, characterized in that the access unit (18) or the playback unit (22) is designed with an embedded functional unit (32) embedded to perform an automatic access to the allocation unit (30) after download access to an electronic document from the document server unit (20), with the functional unit (32) being designed to transmit link or path data assigned to a document affecting its source to (Tr.note: there is a misprint here and the meaning is not clear: The intended version could be “zum Funktionserhalt”=to maintain function, or “zur Funktionseinheit”=to the functional unit)

17. A device as claimed in one of claims 1 to 16, characterized in that the allocation unit (30) comprises means to record user accesses with a data-type signature which cannot be allocated to a reconstruction file (84) or does not exist in the allocation unit (30).

18. A device as claimed in one of claims 1 to 17, characterized in that the local reconstruction unit (34) comprises means to generate an individualized data-type identifier or an electronic water mark on the non-encoded document generated, with the individualized data-type marking corresponding to the data marking of the corresponding encoded document.

19. A device as claimed in one of claims 1 to 18, characterized in that the local reconstruction unit (34) comprises means to facilitate or prevent the local storage of a non-encoded document, preferably in dependence on control data obtained by the reconstruction server unit.

20. Procedure for the copy-protected distribution of electronic documents, characterized by the following steps:
the generation (24) of an encoded form (82) of an electronic document and an associated reconstruction file by a document provider (14), with the encoded document (82) in the encoded form being characterized in that it is fully playable but unusable to the user in the envisaged way and the existence of the encoding of an electronic document (82) is unrecognizable to a machine without an examination of the content of the document and with the information contained in the reconstruction file (84) being suitable in conjunction with the encoded document to restored the original document therefrom,
the storage of the encoded document (82) by the document provider (14) in a document a publicly accessible document server unit (20),
the storage of the reconstruction file (84) by the document provider (84) in a publicly accessible reconstruction server unit (26),
the generation (28) of a signature for the encoded electronic document (82) by the document provider (14) with the objective of facilitating the allocation of a reconstruction file (84) to an associated encoded form (82) of the electronic document, with the means for the generation of the signature (35) from the encoded document being accessible at the user end,
entry of the signature and entry of information on the establishment of a connection or link referring to a reconstruction file belonging to the signature by the document provider in a publicly accessible database (30), with, on the transmission of a signature belonging to the database by a user, the database supplying him with the associated information on the establishment of the connection or link.
access by a user to an encoded document in the document server unit (20) and performance of a procedure to download the encoded document to a local playback unit (22) belonging to the user,
interrogation of the database by means of an access unit (18) allocated to the user, in the linking database (30) and access to the reconstruction server unit (26), use of the reconstruction file (84) and
establishment of the non-encoded file for the user.

21. Procedure as claimed in claim 20, characterized in that the step for the storage of the encoded document in the document server unit (20) includes the storage of a large number of encoded versions of the same non-encoded electronic document.

22. Procedure as claimed in claims 20 or 21 characterized by the local storage of the non-encoded document produced with a data-type individualization in the form of an electronic watermark.
